(19) United States
(12) Patent Application Publication
(10) Pub. No.: US 2010/0120658 A1
(43) Pub. Date: May 13, 2010

(54) Textile Care Agent Having Cellulose Ether Comprising Amine Groups

(75) Inventors: Marc-Steffen Schiedel, Duesseldorf (DE); Noelle Wrubbel, Duesseldorf (DE); Nadine Warkotsch, Duesseldorf (DE); Doris Dahlmann, Duesseldorf (DE)

Correspondence Address: Ratner Prestia, P.O. Box 980, Valley Forge, PA, 19482, US

(73) Assignee: Henkel AG & Co. KGaA, Duesseldorf (DE)

(21) Appl. No.: 12/689,471

(22) Filed: Jan. 19, 2010

Related U.S. Application Data
(63) Continuation of application No. PCT/EP2008/059521, filed on Jul. 21, 2008.

(30) Foreign Application Priority Data
Jul. 31, 2007 (DE) 10 2007 036 394.1

(51) Int. Cl. C11D 3/22; C08B 11/00

(52) U.S. Cl. 510/515; 536/84

(57) ABSTRACT

A textile care agent comprising amine-modified cellulose ether for protecting textiles, and the use of the agent for improving water absorption, for improving shape retention, for lint reduction, for reducing pilling, for reducing wrinkling, for smoothing and improving softness to the touch, and for making ironing easier for textile web materials.

### CROSS REFERENCE TO RELATED APPLICATIONS

This application is a continuation under 35 U.S.C. §§120 and 365(c) of International Application PCT/EP2008/059521, filed on Jul. 21, 2008. This application also claims priority under 35 U.S.C. §119 of DE 10 2007 036 394.1, filed on Jul. 31, 2007. The disclosures of PCT/EP2008/059521 and DE 10 2007 036 394.1 are incorporated herein by reference in their entirety.

### BACKGROUND OF THE INVENTION

The invention relates to a textile care agent containing an amine-modified cellulose ether and to a washing method for washing textiles using this textile washing agent in a conventional domestic washing machine. Furthermore, the invention relates to the use of the textile washing agent for reducing creasing, improving ironing characteristics and improving textile elasticity and softness.

Modern textile cleaning places severe demands on the items of laundry to be cleaned. For instance, frequent washing of garments in automatic washing machines and subsequent drying in a tumble dryer is associated with severe mechanical loading on the fabric. The frictional forces frequently lead to damage to the textile fabric, made apparent by linting and pilling. With every washing or drying cycle, but also as a result of the garments being worn, further abrasion and/or breakage of tiny fibers on the surface of the textile fabric occurs. Conventional textile cleaning agents are not capable of preventing this damage to the fabric or merely attempt to get rid of existing textile damage.

International patent application WO 99/16956 A1 proposes removing lint or pills by using cellulases. In this case, the cellulases degrade microfibers projecting from the textile fabrics and so ensure a smooth and accordingly pill-free textile surface.

A further significant disadvantage of mechanical loading of textile fabrics is the occurrence of creased textile surfaces, undesirable to the user, and the development of rough surfaces. Both the rough textile surfaces and the occurrence of fabric creasing lead to significant impairment of the sliding properties of irons or other textile flattening devices. Flattening rough and creased textiles not only requires greater expenditure of force but also takes significantly longer. The prior art primarily discloses solutions for improving the ironing characteristics of washed textiles which fall into the category of post-treatment agents. Thus, for example, international patent application WO 00/77134 discloses the use of oxidized polyolefins in fabric softener formulations for improving ironing characteristics.

The use of celluloses, hydrogels and acrylic acid polymers as lint reducing components in textile treatment agents is known from German patent application DE 102 03 192 A1.

U.S. Pat. No. 3,472,840 describes quaternary nitrogenous cellulose ethers of the general formula (I),

((R—O—)₃R_{Cell})_{y} (I)

in which R_{Cell} is the residue of an anhydroglucose unit (C₆H₁₀O₅), the degree of polymerization y is a number from 50 to 20000 and each of the residues R corresponds to the general formula (II).

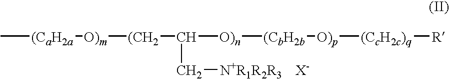

in which a and b are mutually independently 2 or 3, c is 1, 2 or 3, m and p are mutually independently an integer from 0 to 10, n is an integer from 0 to 3, q is 0 or 1, X⁻ is an anion which is present in such a number, depending on its charge, that it equalizes the positive charges of the quaternary nitrogen atoms, and R′ is hydrogen, a carboxylic acid group or a sodium, potassium or ammonium carboxylate group, with the proviso that R′ is hydrogen if q is 0. The compounds of the formula I may, as described therein, be obtained by reacting conventional or previously specially produced nonionic cellulose ethers with quaternary halohydrins or quaternary epoxides.

Similarly, corresponding amine-substituted derivatives, in which the nitrogen atoms in the substituent are not quaternized, are obtained from cellulose ethers by reaction with haloalkylamines, epoxy alkylamines or by reaction with epoxyalkyl halides (for example epichlorohydrin) and subsequent reaction with amines.

### DESCRIPTION OF THE INVENTION

It has surprisingly now been found that the use of certain amine-substituted cellulose derivatives in the washing process leads to a significant improvement in fiber and textile properties.

The present invention accordingly provides in a first embodiment a textile care agent containing nitrogenous cellulose ethers of the general formula (I),

((R—O—)₃R_{Cell})_{y} (I)

in which R_{Cell} is the residue of an anhydroglucose unit, the degree of polymerization y is a number from 80 to 65000 and each of the residues R corresponds to the general formula (II),

—(CₐH₂ₐ—O)ₘ—(C_{b}H_{2b}—O)ₙ—(C_{c}H_{2c})ₒ—R¹Yₚ (II)

in which a and b are mutually independently 2 or 3, c is a number from 1 to 10, m and n are mutually independently a number from 0 to 10, o is 0 or 1, R¹ denotes hydrogen, a C₁₋₁₅ alkyl, alkylaryl, arylalkyl or aryl residue, the group —NR²R³(R⁴)_{q}, a C₁₋₁₈ alkyl, alkylaryl, arylalkyl or aryl carboxylic acid group or a corresponding sodium, potassium or ammonium carboxylate group, R², R³ and R⁴ mutually independently denote hydrogen, a C₁₋₁₈ alkyl, alkylaryl, arylalkyl or aryl residue or a C₁₋₁₈ alkyl, alkylaryl, arylalkyl or aryl carboxylic acid group or a corresponding sodium, potassium or ammonium carboxylate group, q is 0 or 1, Y denotes an anion, in particular halide, carbonate, phosphate, sulfate, C₁₋₂₂ carboxylate, C₁₋₂₂ alkyl sulfate, C₁₋₂₂ alkanesulfonate or C₁₋₂₂ alkylbenzene sulfonate and p is a number greater than or equal to zero, such that the complete molecule of the formula (I) does not exhibit a charge, providing that, in at least one of the residues R, the grouping —R¹ denotes —NR²R³(R⁴)_{q}.

As explained above, such amine-modified cellulose ethers may straightforwardly be obtained by reaction of at least one hydroxyl group of cellulose and/or cellulose ethers containing hydroxyl groups, for example alkyl, carboxyalkyl, alkylcarboxyalkyl, hydroxyalkyl or alkylhydroxyalkyl cellulose ethers, with haloalkylamines. Haloalkylamines which are worthy of particular consideration are trialkylamines in which one alkyl group bears a halogen atom, in particular chlorine. Among these, 1-diethylamino-2-chloroethane, 2-chloro-N,N-dimethylpropylamine and 3-chloro-N,N-dimethylpropylamine are particularly preferred. When using haloalkylamines, in order to avoid a nucleophilic reaction of the amine nitrogen, the latter may be present in conventional manner in salt form, for example as the hydrochloride. If desired, the free amines of the general formula (I) with z=0 may be obtained by subsequent neutralization.

For the purposes of the present invention, textile care agents are taken to mean not only washing and cleaning agents and pretreatment agents, but also agents for conditioning textile fabrics, such as light-duty detergents and post-treatment agents, such as rinse conditioners. Conditioning should here be taken to mean softening treatment of textile fabrics, materials, yarns and woven fabrics. Conditioning is intended to impart positive characteristics to the textiles, such as for example an improved soft hand, increased luster and color brightness, revived fragrance and a reduction in creasing and static charging.

Use of agents according to the invention in particular prevents textile creasing due to the washing and/or drying process, improves softness and ironing characteristics of the textile and considerably reduces “sagging” of the textiles on washing. In addition, in particular in the case of synthetic fibers, which are otherwise generally largely incapable of absorbing moisture such as for example perspiration, water absorption capacity is significantly increased by using agents according to the invention, so distinctly improving the wearing comfort of the textiles.

The textile care agents according to the invention may assume not only solid form, in particular as a powder, granular product, extrudate, pressed and/or fused molding such as a tablet, but also liquid form, in particular as a dispersion, suspension, emulsion, solution, microemulsion, gel or paste In a preferred embodiment of the invention they are liquid. The agents according to the invention preferably contain 0.001 wt. % to 5 wt. %, in particular 0.1 wt. % to 1 wt. % of an amine-modified cellulose ether of the general formula (I). In the compounds according to formula (I), y is preferably in the range from 200 to 35000, in particular in the range from 300 to 20000. Per grouping R_{Cell} in the compound according to formula (I), there are on average preferably 0.01 to 1, in particular 0.1 to 0.8 residues R¹ which correspond to the grouping NR²R³(R⁴)_{q}, in other words, averaged over the entire cellulose ether, preferably one in every hundred to every one, in particular one in ten to eight in ten of the anydroglucose units is/are substituted with a group bearing a nitrogen atom. In addition to the groups bearing the nitrogen atom, the cellulose ethers to be used according to the invention preferably contain carboxymethyl, methyl, ethyl, propyl, hydroxyethyl and/or hydroxypropyl groups. These groups constitute a proportion of the residues R and/or, as a subgrouping —(CₐH₂ₐ—O)ₘ—(C_{b}H_{2b}—O)ₙ—(C_{c}H_{2c})ₒ—, are a component of the group bearing the nitrogen atom.

The average molecular weight Mw of the cellulose ethers to be used according to the invention is preferably above 5000, particularly preferably above 10000, in particular between 30000 and 1000000, advantageously between 50000 and 800000 g/mol and extremely preferably between 200000 and 600000 g/mol. Molecular weight may be determined by gel permeation chromatography, for example relative to normalized polyacrylic acid standards.

In a preferred embodiment of the present invention, the textile care agents contain complexing agents in addition to the amine-modified cellulose ether. It has surprisingly been found that in particular organic, advantageously water-soluble, complexing agents may particularly readily be incorporated into the textile care agents according to the invention and, in particular together with the cellulose ethers to be used according to the invention, impart elevated stability to the textile care agent, in particular those which are liquid preparations. The complexing agents improve the stability of the agents and provide protection, for example, from the heavy metal-catalysed decomposition of certain ingredients of detergent formulations. Together with the cellulose ethers to be used according to the invention, they contribute to inhibiting scale formation. The group of complexing agents includes for example the salts, in particular the alkali metal salts, of nitrilotriacetic acid (NTA) and the derivatives thereof as well as alkali metal salts of anionic polyelectrolytes such as polymaleates and polysulfonates. Citric acid, adipic acid, succinic acid, glutaric acid, malic acid, tartaric acid, maleic acid, fumaric acid, saccharic acids, aminocarboxylic acids and the derivatives thereof and mixtures of these are furthermore suitable. These preferred compounds include in particular organophosphonates such as for example 1-hydroxyethane-1,1-diphosphonic acid (HEDP), aminotri(methylenephosphonic acid) (ATMP), diethylenetriamine penta(methylenephosphonic acid) (DTPMP or DETPMP) and 2-phosphonobutane-1,2,4-tricarboxylic acid (PBS-AM), which are generally used in the form of the ammonium or alkali metal salts thereof. Citric acid and/or the alkali metal salts thereof, for example sodium citrate and/or potassium citrate, is/are particularly preferably suitable for the purposes of the present invention.

In a preferred embodiment, the textile care agents contain complexing agents in a quantity of up to 20 wt. %, preferably of 0.01 to 15 wt. %, particularly preferably of 0.1 to 10 and in particular of 0.3 to 5.0 wt. %, advantageously of 1.5 to 3 wt. %, in each case relative to the entire agent.

In a preferred embodiment, the textile care agents according to the invention additionally contain nonionic surfactants. The use of nonionic surfactants not only increases the washing performance of the agents according to the invention, but additionally assists the dispersion and homogeneous distribution of the cellulose ether to be used according to the invention.

The nonionic surfactants used are preferably alkoxylated, advantageously ethoxylated and/or propoxylated, in particular primary alcohols with preferably 8 to 18 C atoms and on average 1 to 12 mol of ethylene oxide (EO) and/or 1 to 10 mol of propylene oxide (PO) per mol of alcohol. C₈-C₁₆ alcohol alkoxylates are particularly preferred, advantageously ethoxylated and/or propoxylated C₁₀-C₁₅ alcohol alkoxylates, in particular C₁₂-C₁₄ alcohol alkoxylates, with a degree of ethoxylation of between 2 and 10, preferably of between 3 and 8, and/or a degree of propoxylation of between 1 and 6, preferably of between 1.5 and 5. The alcohol residue may preferably be linear or particularly preferably methyl-branched in position 2 or contain linear and methyl-branched residues in a mixture, as are conventionally present in oxo alcohol residues. In particular, however, alcohol ethoxylates with linear residues prepared from alcohols of natural origin with 12 to 18 C atoms, for example from coconut, palm, tallow fat or oleyl alcohol, and on average 2 to 8 ED per mol of alcohol are preferred. Preferred ethoxylated alcohols include, for example, C₁₂₋₁₄ alcohols with 3 EO or 4 EO, C₉₋₁₁ alcohol with 7 EO, C₁₃₋₁₅ alcohols with 3 EO, 5 ED, 7 EO or 8 EO, C₁₂₋₁₈ alcohols with 3 EO, 5 EO or 7 EO and mixtures of these, such as mixtures of C₁₂₋₁₄ alcohol with 3 EO and C₁₂₋₁₈ alcohol with 5 EO. The stated degrees of ethoxylation and propoxylation are statistical averages which, for a specific product, may be an integer or a fractional number. Preferred alcohol ethoxylates and propoxylates have a narrow homolog distribution (narrow range ethoxylates/propoxylates, NRE/NRP). In addition to these nonionic surfactants, fatty alcohols with more than 12 ED may also be used. Examples of these are tallow fatty alcohol with 14 ED, 25 EO, 30 EO or 40 EO.

Also suitable are alkoxylated amines, advantageously ethoxylated and/or propoxylated, in particular primary and secondary amines with preferably 1 to 18 C atoms per alkyl chain and on average 1 to 12 mol of ethylene oxide (ED) and/or 1 to 10 mol of propylene oxide (PO) per mol of amine.

End group-terminated alkoxylated fatty amines and fatty alcohols have proved particularly advantageous, in particular for use in nonaqueous formulations according to the invention. In the case of end group-terminated fatty alcohol alkoxylates and fatty amine alkoxylates, the terminal hydroxyl groups of the fatty alcohol ethoxylates and fatty amine alkoxylates are etherified by C₁-C₂₀ alkyl groups, preferably methyl or ethyl groups.

Alkyl glycosides of the general formula RO(G)ₓ may moreover also be used as further nonionic surfactants, for example as compounds, in particular with anionic surfactants, in which R means a primary straight-chain or methyl-branched aliphatic residue, in particular methyl-branched in position 2, with 8 to 22, preferably 12 to 18 C atoms and G is the symbol which denotes a glycose unit with 5 or 6 C atoms, preferably glucose. The degree of oligomerization x, which indicates the distribution of monoglycosides and oligoglycosides, is any desired number between 1 and 10; x is preferably 1.2 to 1.4.

A further class of preferably used nonionic surfactants, which may be used either as sole nonionic surfactant or in combination with other nonionic surfactants, are alkoxylated, preferably ethoxylated or ethoxylated and propoxylated fatty acid alkyl esters, preferably with 1 to 4 carbon atoms in the alkyl chain, in particular fatty acid methyl esters.

“Gemini” surfactants may also be considered as further surfactants. These are generally taken to mean those compounds which have two hydrophilic groups and two hydrophobic groups per molecule. These groups are generally separated from one another by a “spacer”. This spacer is generally a carbon chain which should be long enough for the hydrophilic groups to be sufficiently far apart that they can act mutually independently. Such surfactants are in general distinguished by an unusually low critical micelle concentration and the ability to bring about a great reduction in the surface tension of water. In exceptional cases, however, gemini surfactants are taken to mean not only such dimeric surfactants, but also corresponding trimeric surfactants.

Suitable gemini surfactants are for example sulfated hydroxy mixed ethers or dimer alcohol bis- and trimer alcohol tris-sulfates and -ether sulfates. End group-terminated dimeric and trimeric mixed ethers are distinguished as a rule by their di- and multifunctionality. The stated end group-terminated surfactants accordingly exhibit good wetting characteristics and are low-foaming, such that they are in particular suitable for use in machine washing or cleaning methods.

Gemini polyhydroxyfatty acid amides or poly-polyhydroxyfatty acid amides may, however also be used.

Further suitable surfactants are polyhydroxyfatty acid amides of the formula,

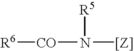

in which R⁶CO denotes an aliphatic acyl residue having 6 to 22 carbon atoms, R⁵ denotes hydrogen, an alkyl or hydroxyalkyl residue having 1 to 4 carbon atoms and [Z] denotes a linear or branched polyhydroxyalkyl residue having 3 to 10 carbon atoms and 3 to 10 hydroxyl groups. The polyhydroxyfatty acid amides comprise known substances which may conventionally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds of the following formula,

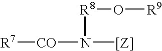

in which R⁷ denotes a linear or branched alkyl or alkenyl residue with 7 to 12 carbon atoms, R⁸ denotes a linear, branched or cyclic alkyl residue or an aryl residue with 2 to 8 carbon atoms and R⁹ denotes a linear, branched or cyclic alkyl residue or an aryl residue or an oxyalkyl residue with 1 to 8 carbon atoms, wherein C₁₋₄ alkyl or phenyl residues are preferred, and [Z] denotes a linear polyhydroxyalkyl residue, the alkyl chain of which is substituted with at least two hydroxyl groups, or alkoxylated, preferably ethoxylated or propoxylated derivatives of this residue. [Z] is preferably obtained by reductive amination of a reduced sugar, for example glucose, fructose, maltose, lactose, galactose, mannose or xylose. The N-alkoxy- or N-aryloxy-substituted compounds may then be converted into the desired polyhydroxyfatty acid amides by reaction with fatty acid methyl esters in the presence of an alkoxide as catalyst.

It has proved advantageous for the textile care agents according to the invention if nonionic surfactants selected from the group of alkoxylated fatty alcohols and/or alkyl glycosides, in particular mixtures of alkoxylated fatty alcohols and alkyl glycosides, are used.

In a preferred embodiment, the textile care agents according to the invention contain nonionic surfactants in quantities of up to 35 wt. %, preferably of 5 to 25 wt. %, particularly preferably of 10 to 20 wt. %, in each case relative to the entire agent.

The textile care agents according to the invention may furthermore also contain anionic surfactants in addition to or instead of nonionic surfactants. Using anionic surfactants distinctly enhances the soil detachment behavior of the agents according to the invention during the washing process, without in so doing substantially impairing the action of the cellulose ethers to be used according to the invention as a lint-reducing component and anticrease component, despite their cationic charge.

The anionic surfactants used may for example be those of the sulfonate and sulfate type. Surfactants of the sulfonate type which may here preferably be considered are C₉₋₁₃ alkylbenzene sulfonates, olefin sulfonates, i.e. mixtures of alkene and hydroxyalkane sulfonates and disulfonates, as are obtained, for example, from C₁₂₋₁₈ monoolefins with a terminal or internal double bond by sulfonation with gaseous sulfur trioxide and subsequent alkaline or acidic hydrolysis of the sulfonation products. Alkane sulfonates which are obtained from C₁₂₋₁₈ alkanes for example by sulfochlorination or sulfoxidation with subsequent hydrolysis or neutralization are also suitable. Likewise, the esters of α-sulfofatty acids (ester sulfonates) are also suitable, for example the α-sulfonated methyl esters of hydrogenated coconut, palm kernel or tallow fatty acids.

Further suitable anionic surfactants are sulfated fatty acid glycerol esters. Fatty acid glycerol esters are understood to mean mono-, di- and triesters and mixtures thereof, as are obtained during production by esterification of a monoglycerol with 1 to 3 mol of fatty acid or on transesterification of triglycerides with 0.3 to 2 mol of glycerol. Preferred sulfated fatty acid glycerol esters are here the sulfation products of saturated fatty acids with 6 to 22 carbon atoms, for example of caproic acid, caprylic acid, capric acid, myristic acid, lauric acid, palmitic acid, stearic acid or behenic acid.

Preferred alk(en)yl sulfates are the alkali metal and in particular sodium salts of sulfuric acid semi-esters of C₁₂-C₁₈ fatty alcohols for example prepared from coconut fatty alcohol, tallow fatty alcohol, lauryl, myristyl, cetyl or stearyl alcohol or C₁₀-C₂₀ oxo alcohols and those semi-esters of secondary alcohols of these chain lengths. Alk(en)yl sulfates of the stated chain length which contain a synthetic straight-chain alkyl residue produced on a petrochemical basis and which exhibit degradation behavior similar to that of the appropriate compounds based on fatty chemical raw materials are also preferred. C₁₂-C₁₆ alkyl sulfates and C₁₂-C₁₅ alkyl sulfates and C₁₄-C₁₅ alkyl sulfates are preferred because of their washing characteristics. 2,3-Alkyl sulfates, which may for example be obtained as commercial products from Shell Oil Company under the name DAN®, are also suitable anionic surfactants.

The sulfuric acid monoesters of straight-chain or branched C₇₋₂₁ alcohols ethoxylated with 1 to 6 mol of ethylene oxide are also suitable and are particularly preferred anionic surfactants for the purposes of the present invention, such as 2-methyl-branched C₉₋₁₁ alcohols with on average 3.5 mol of ethylene oxide (EO) or C₁₂₋₁₈ fatty alcohols with 1 to 4 EO, which are known as fatty alcohol ether sulfates.

Further suitable anionic surfactants are also the salts of alkylsulfosuccinic acid, which are also known as sulfosuccinates or sulfosuccinic acid esters, and are the monoesters and/or diesters of sulfosuccinic acid with alcohols, preferably fatty alcohols and in particular ethoxylated fatty alcohols. Preferred sulfosuccinates contain C₈₋₁₈ fatty alcohol residues or mixtures thereof. Particularly preferred sulfosuccinates contain a fatty alcohol residue which is derived from ethoxylated fatty alcohols, which are in themselves nonionic surfactants. Sulfosuccinates whose fatty alcohol residues are derived from ethoxylated fatty alcohols with a narrow homolog distribution are here in turn particularly preferred. It is likewise also possible to use alk(en)ylsuccinic acid with preferably 8 to 18 carbon atoms in the alk(en)yl chain or the salts thereof.

Further anionic surfactants which may in particular be considered are soaps. Saturated fatty acid soaps are, for example, suitable, such as the salts of lauric acid, myristic acid, palmitic acid, stearic acid, hydrogenated erucic acid and behenic acid and in particular soap mixtures derived from natural fatty acids, for example coconut, palm kernel or tallow fatty acids.

The anionic surfactants, including the soaps, may be present in the form of the sodium, potassium or ammonium salts thereof and as soluble salts of organic bases, such as mono-, di- or triethanolamine. The anionic surfactants are preferably present in the form of the sodium or potassium salts thereof, in particular in the form of the sodium salts. The ammonium salts, in particular the salts of organic bases, such as for example isopropylamine, are however preferred for the non-aqueous liquid washing agents according to the invention.

A further class of anionic surfactants is the class of ether carboxylic acids obtainable by reacting fatty alcohol ethoxylates with sodium chloroacetate in the presence of basic catalysts. They have the general formula: R¹⁰—O—(CH₂—CH₂—O)ₚ—CH₂—COOH with R¹⁰=C₁-C₁₈ and p=0.1 to 20. Ether carboxylic acids are insensitive to water hardness and exhibit excellent surfactant characteristics.

In a preferred embodiment, the textile cleaning agents according to the invention contain anionic surfactants, preferably selected from the group of fatty alcohol sulfates and/or fatty alcohol ether sulfates and/or alkylbenzene sulfonates and/or soaps.

The content of anionic surfactants may vary considerably depending on the intended application of the textile care agents according to the invention. If the textile care agents assume the form of light-duty detergents or post-treatment agents, for example of rinse conditioners, the quantities are usually below 10 wt. %, preferably below 5 wt. % and in particular below 1 wt. %, in each case relative to the entire agent.

If the textile care agents assume the form of a solid or liquid complete washing agent, for example of a nonaqueous liquid washing agent, anionic surfactants may be present in quantities of up to 65 wt. %, preferably in quantities of up to 50 wt. %, particularly preferably in quantities of 5 to 35 wt. %, in each case relative to the entire agent.

In a preferred embodiment, the textile care agents according to the invention may furthermore additionally contain enzymes.

Enzymes assist washing processes in many and varied ways, in particular in removing poorly bleachable contaminants, such as for example protein soiling. However, incorporating enzymes into washing agent formulations, in particular into liquid textile care agents, is often problematic, since incompatibilities may arise with other components of the washing agent, which may in turn result in a loss of activity of the enzymes. It has surprisingly been found that the use of the copolymers to be used according to the invention may improve the stability of the enzymes in the washing liquor or textile care agent formulation, in particular in liquid textile care agent formulations.

Enzymes which may in particular be considered are those from the classes of hydrolases such as proteases, esterases, lipases or lipolytically active enzymes, amylases, cellulases or other glycosylhydrolases and mixtures of the stated enzymes. In laundry, all these hydrolases contribute to the removal of stains such as those containing protein, fat or starch and of graying. By removing pilling and microfibrils, cellulases and other glycosylhydrolases may furthermore contribute to color retention and to increasing textile softness. Oxyreductases may also be used for bleaching or for inhibiting color transfer. Enzymatic active substances isolated from strains of bacteria or fungi such as Bacillus subtilis, Bacillus licheniformis, Streptomyces griseus and Humicola insolens are particularly suitable. Proteases of the subtilisin type and in particular proteases isolated from Bacillus lentus are preferably used. Enzyme mixtures, for example of protease and amylase or protease and lipase or lipolytically active enzymes or protease and cellulase or of cellulase and lipase or lipolytically active enzymes or of protease, amylase and lipase or lipolytically active enzymes or protease, lipase or lipolytically active enzymes and cellulase, but in particular mixtures containing protease and/or lipase or mixtures with lipolytically active enzymes are of particular interest for this purpose. Examples of such lipolytically active enzymes are the known cutinases. Peroxidases or oxidases have also proved suitable in some cases. Suitable amylases include in particular α-amylases, iso-amylases, pullulanases and pectinases. Cellobiohydrolases, endoglucanases and β-glucosidases, which are also known as cellobiases, or mixtures of these are preferably used as cellulases. Since different types of cellulase may differ in terms of their CMCase and avicelase activities, desired activities may be established by targeted mixing of the cellulases.

The enzymes may be adsorbed on support materials and/or coated in order to protect them from premature breakdown.

In a preferred embodiment, the textile care agents according to the invention contain enzymes, preferably selected from the group of proteases and/or amylases and/or cellulases.

If the textile care agents according to the invention assume the form of light-duty detergents or post-treatment agents, for example the form of rinse conditioners, they may in a preferred embodiment contain cellulase, preferably in a quantity of 0.005 to 2 wt. %, particularly preferably of 0.01 to 1 wt. %, in particular of 0.02 to 0.5 wt. %, in each case relative to the entire agent.

In a preferred embodiment, the textile care agents according to the invention assume liquid form and advantageously have a viscosity of 50 to 5000 mPa·s, particularly preferably of 50 to 3000 mPa·s and in particular of 500 to 1500 mPa·s (measured at 20° C. with a rotational viscometer (Brookfield RV, spindle 2) at 20 rpm (revolutions per minute)).

In a preferred embodiment, preferred liquid textile care agents contain one or more non-aqueous, water-miscible solvents.

Solvents which may be used in the aqueous agents according to the invention, originate for example from the group of mono- or polyhydric alcohols, alkanolamines or glycol ethers, providing that they are water-miscible in the concentration range desired for use. The solvents are preferably selected from ethanol, n- or i-propanol, butanols, glycol, propane- or butanediol, glycerol, diglycol, diethylene glycol monopropyl or monobutyl ether, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, butoxypropoxypropanol (BPP), dipropylene glycol monomethyl or monoethyl ether, diisopropylene glycol monomethyl or monoethyl ether, methoxy, ethoxy or butoxytriglycol, 1-butoxyethoxy-2-propanol, 3-methyl-3-methoxybutanol, propylene glycol t-butyl ether and mixtures of these solvents.

Some glycol ethers are obtainable under the trade names Arcosolv® (Arco Chemical Co.) or Cellosolve®, Carbitol® or Propasol® (Union Carbide Corp.); these also include also for example ButylCarbitol®, HexylCarbitol®, MethylCarbitol®, and Carbitol® itself, (2-(2-ethoxy)ethoxy)ethanol. The glycol ether may be readily selected by a person skilled in the art on the basis of its volatility, water solubility, its percentage by weight in the entire agent and the like. Pyrrolidone solvents, such as N-alkylpyrrolidones, for example N-methyl-2-pyrrolidone or N—C₈-C₁₂-alkylpyrrolidone or 2-pyrrolidone, may likewise be used. In addition, alcohols may preferably be used. These include liquid polyethylene glycols, of low molecular weight, for example polyethylene glycols with a molecular weight of 200, 300, 400 or 600. Further suitable alcohols are for example lower alcohols such as ethanol, propanol, isopropanol and n-butanol, C₂-C₄ polyols, such as diols or triols, for example ethylene glycol, propylene glycol, glycerol or mixtures thereof.

In a preferred embodiment, the textile care agents according to the invention contain, if they assume liquid form, up to 95 wt. %, particularly preferably 20 to 90 wt. % and in particular 50 to 80 wt. % of one or more solvents, preferably water-soluble solvents and in particular water.

In a preferred embodiment of the invention, the textile care agents additionally contain softener components, preferably cationic surfactants. If, in particular, the textile care agents according to the invention assume the form of light-duty detergents or textile post-treatment agents, for example the form of rinse conditioners, the use of additional softener components has proven extremely advantageous. In particular, when washing sensitive textiles, such as for example silk, wool or linen, which are washed and ironed at low temperatures, the use of softener components has proven useful. In addition to the cellulose ethers to be used according to the invention, the softener components additionally facilitate ironing of the textiles and reduce the static charging of the textile materials.

Examples of such fabric-softening components are quaternary ammonium compounds, cationic polymers and emulsifiers, as are used in hair care products and also in textile finishing agents.

Suitable examples are quaternary ammonium compounds of the formulae (III) and (IV),

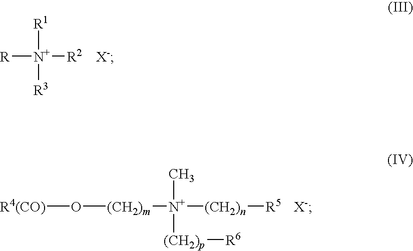

with, in (III), R and R¹ denoting an acyclic alkyl residue with 12 to 24 carbon atoms, R² denoting a saturated C₁-C₄ alkyl or hydroxyalkyl residue, R³ being either identical to R, R¹ or R² or denoting an aromatic residue. X⁻ denotes alternatively a halide, methosulfate, methophosphate or phosphate ion and mixtures of these. Examples of cationic compounds of the formula (III) are didecyldimethylammonium chloride, ditallowedimethylammonium chloride or dihexadecylammonium chloride.

Compounds of the formula (IV) are known as “ester quats”. Ester quats are distinguished by their good biodegradability and are particularly preferred for the purposes of the present invention. R⁴ here denotes an aliphatic alkyl residue with 12 to 22 carbon atoms with 0, 1, 2 or 3 double bonds; R⁵ denotes H, OH, or O(CO)R⁷, R⁶, independently of R⁵, denotes H, OH, or O(CO)R⁸, R⁷ and R⁸ mutually independently in each case denoting an aliphatic alkyl residue with 12 to 22 carbon atoms with 0, 1, 2 or 3 double bonds; m, n and p may in each case mutually independently have the value 1, 2 or 3. X″ may be alternatively a halide, methosulfate, methophosphate or phosphate ion and mixtures of these. Preferred compounds are those which, for R⁵, contain the group O(CO)R⁷ and, for R⁴ and R⁷, contain alkyl residues with 16 to 18 carbon atoms. Particularly preferred compounds are those in which R⁶ additionally denotes OH. Examples of compounds of the formula (IV) are methyl-N-(2-hydroxyethyl)-N,N-di(tallowacyloxyethyl)ammonium methosulfate, bis-(palmitoyl)-ethylhydroxyethylmethylammonium methosulfate or methyl-N,N-bis(acyloxyethyl)-N-(2-hydroxyethyl)ammonium methosulfate. If quaternized compounds of the formula (IV) which comprise unsaturated alkyl chains are used, preferred acyl groups are those whose corresponding fatty acids exhibit an iodine value of between 5 and 80, preferably of between 10 and 60 and in particular of between 15 and 45 and which have a cis/trans isomer ratio (in wt. %) of greater than 30:70, preferably of greater than 50:50 and in particular of greater than 70:30. Conventional commercial examples are the methylhydroxyalkyldialkoyloxyalkylammonium methosulfates distributed by Stepan under the trademark Stepantex® or the Cognis products known by the name Dehyquart or the Goldschmidt-Witco products known by the name Rewoquat®. Further preferred compounds are the diester quats of the formula (V), which are obtainable under the name Rewoquat® W 222 LM or CR 3099 and, in addition to softness, also provide stability and color protection.

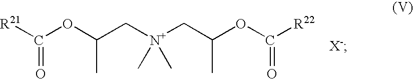

R²¹ and R²² here mutually independently in each case denote an aliphatic residue with 12 to 22 carbon atoms with 0, 1, 2 or 3 double bonds.

In addition to the above-described quaternary compounds, other known compounds may also be used, such as for example quaternary imidazolinium compounds of the formula (VI),

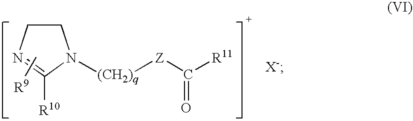

R⁹ denoting H or a saturated alkyl residue with 1 to 4 carbon atoms, R¹⁰ and R¹¹ mutually independently in each case denoting an aliphatic, saturated or unsaturated alkyl residue with 12 to 18 carbon atoms, R¹⁰ alternatively possibly also denoting O(CO)R²⁰, R²⁰ meaning an aliphatic, saturated or unsaturated alkyl residue with 12 to 18 carbon atoms, and Z meaning an NH group or oxygen and X⁻ being an anion. q may assume integral values between 1 and 4.

Further suitable quaternary compounds are described by the formula (VII),

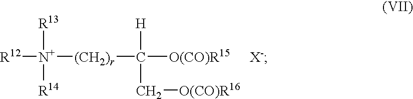

R¹², R¹³ and R¹⁴ mutually independently denoting a C₁₋₄ alkyl, alkenyl or hydroxyalkyl group, R¹⁵ and R¹⁶, in each case independently selected, representing a C₈₋₂₈ alkyl group and r being a number between 0 and 5.

In addition to the stated compounds of the formulae (III) to (VII), short-chain, water-soluble, quaternary ammonium compounds may also be used, such as trihydroxyethylmethylammonium methosulfate or alkyltrimethylammonium chloride, dialkyldimethylammonium chlorides and trialkylmethylammonium chlorides, for example cetyltrimethylammonium chloride, stearyltrimethylammonium chloride, distearyldimethylammonium chloride, lauryldimethylammonium chloride, lauryldimethylbenzylammonium chloride and tricetylmethylammonium chloride.

Protonated alkylamine compounds which exhibit a softening action and the non-quaternized, protonated precursors of cationic emulsifiers are also suitable.

Quaternized protein hydrolysates are further cationic compounds which are usable according to the invention.

Suitable cationic polymers include polyquaternium polymers, as are mentioned in the CTFA Cosmetic Ingredient Dictionary (The Cosmetic, Toiletry and Fragrance Association, Inc., 1997), in particular polyquaternium-6, polyquaternium-7, polyquaternium-10 polymers (Ucare Polymer IR 400; Amerchol) also known as Merquats, polyquaternium-4 copolymers, such as graft copolymers with a cellulose skeleton and quaternary ammonium groups, which are attached via allyldimethylammonium chloride, cationic cellulose derivatives, such as cationic guar, such as guarhydroxypropyltriammonium chloride, and similar quaternized guar derivatives (for example Cosmedia Guar, manufacturer: Cognis GmbH), cationic quaternary sugar derivatives (cationic alkyl polyglucosides), for example the commercial product Glucquat®100, according to CTFA nomenclature a “Lauryl Methyl Gluceth-10 Hydroxypropyl Dimonium Chloride”, copolymers of PVP and dimethylamino methacrylate, copolymers of vinylimidazole and vinylpyrrolidone, aminosilicone polymers and copolymers.

Polyquaternized polymers (for example Luviquat® Care from BASF) may also be used, and also chitin-based cationic biopolymers and the derivatives thereof, for example the polymer obtainable under the tradename Chitosan® (manufacturer: Cognis).

Cationic silicone oils are likewise suitable, such as for example the commercially obtainable products Q2-7224 (manufacturer: Dow Corning; a stabilized trimethylsilylamodimethicone), Dow Corning 929 Emulsion (containing a hydroxylamine-modified silicone which is also designated an amodimethicone), SM-2059 (manufacturer: General Electric), SLM-55067 (manufacturer: Wacker), Abil®-Quat 3270 and 3272 (manufacturer: Goldschmidt-Rewo; diquaternary polydimethylsiloxane, Quaternium-80), and Siliconquat Rewoquat® SQ 1 (Tegopren® 6922, manufacturer: Goldschmidt-Rewo).

Compounds of the formula (VIII) may also be used,

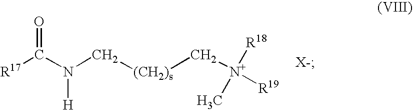

which may be alkylamidoamines in their non-quaternized or, as shown, their quaternized form. R¹⁷ may be an aliphatic alkyl residue with 12 to 22 carbon atoms with 0, 1, 2 or 3 double bonds, s may assume values between 0 and 5. R¹⁸ and R¹⁹ denote mutually independently in each case H, C₁₋₄ alkyl or hydroxyalkyl. Preferred compounds are fatty acid amidoamines such as the stearylamidopropyldimethylamine obtainable under the name Tego Amide®S 18 or the 3-tallowamidopropyltrimethylammonium methosulfate obtainable under the name Stepantex® X 9124, which are distinguished by a dye transfer-inhibiting action and especially by their good biodegradability in addition to having a good conditioning action. Alkylated quaternary ammonium compounds, at least one alkyl chain of which is interrupted by an ester group and/or amido group, in particular N-methyl-N(2-hydroxyethyl)-N,N-(ditallowacyloxyethyl)ammonium methosulfate and/or N-methyl-N(2-hydroxyethyl)-N,N-(palmitoyloxyethyl)ammonium methosulfate are particularly preferred.

Nonionic softeners which may primarily be considered are polyoxyalkylene glycerol alkanoates, polybutylenes, long-chain fatty acids, ethoxylated fatty acid ethanolamides, alkyl polyglycosides, sorbitan mono-, di- and triesters and fatty acid esters of polycarboxylic acids.

In a preferred embodiment, light-duty detergents according to the invention contain cationic surfactants, preferably alkylated quaternary ammonium compounds, at least one alkyl chain of which is interrupted by an ester group and/or amido group, in particular N-methyl-N(2-hydroxyethyl)-N,N-(ditallowacyloxyethyl)ammonium methosulfate or N-methyl-N(2-hydroxyethyl)-N,N-(palmitoyloxyethyl)ammonium methosulfate.

In a further preferred embodiment, the textile care agents according to the invention contain softener components in a quantity of up to 35 wt. %, preferably of 0.1 to 25 wt. %, particularly preferably of 0.5 to 15 wt. % and in particular of 1 to 10 wt. %, in each case relative to the total agent.

In a particularly preferred embodiment of the invention, the textile care agents according to the invention assume the form of light-duty detergents or rinse conditioners, containing softeners, preferably cationic softeners, particularly preferably ester quats.

In addition to the above-stated components, the textile care agents according to the invention contain pearlescent agents. Pearlescent agents lend the textiles additional luster and are therefore preferably used in light-duty detergents according to the invention.

Examples of pearlescent agents are: alkylene glycol esters; fatty acid alkanolamides; partial glycerides; esters of polyvalent, optionally hydroxy-substituted carboxylic acids with fatty alcohols with 6 to 22 carbon atoms; fatty substances, such as for example fatty alcohols, fatty ketones, fatty aldehydes, fatty ethers and fatty carbonates, which comprise in total at least 24 carbon atoms; ring-opening products of olefin epoxides having 12 to 22 carbon atoms with fatty alcohols having 12 to 22 carbon atoms, fatty acids and/or polyols having 2 to 15 carbon atoms and 2 to 10 hydroxyl groups and mixtures thereof.

In addition, liquid textile care agents according to the invention may additionally contain thickeners. The use of thickeners has proven particularly advantageous in the textile care agents according to the invention which are used as liquid washing agents. To increase consumer acceptance, the use of thickeners has proven useful in particular in gel-form liquid washing agents. The thickened consistency of the agent facilitates application of the agents directly onto the stains to be treated. Running away, as tends to occur with highly-fluid agents, is thereby prevented.

Polymers originating from natural sources which may be used as thickeners are for example agar-agar, carrageenan, tragacanth, gum arabic, alginates, pectins, polyoses, guar flour, locust bean flour, starch, dextrins, gelatin and casein.

Modified natural substances originate above all from the group of modified starches and celluloses, examples which may be stated being carboxymethylcellulose and nonionic cellulose ethers such as hydroxyethyl- and hydroxypropylcellulose and seed flour ether.

A large group of thickeners, which are widely used in the most varied range of fields, are fully synthetic polymers such as polyacrylic and polymethacrylic compounds, vinyl polymers, polycarboxylic acids, polyethers, polyimines, polyamides and polyurethanes.

Thickeners from the stated classes of substances are commercially widely available and are obtainable for example under the trade names Acusol®-820 (methacrylic acid(stearyl alcohol-20-EO-)ester-acrylic acid copolymer, 30% in water, Rohm & Haas), Dapral®-GT-282-S (alkyl polyglycol ether, Akzo), Deuterol®-Polymer-11 (dicarboxylic acid copolymer, Schoner GmbH), Deuteron®-XG (anionic heteropolysaccharide based on β-D-glucose, D-mannose, D-glucuronic acid, Schöner GmbH), Deuteron®-XN (non-ionogenic polysaccharide, SchOner GmbH), Dicrylan®Thickener 0 (ethylene oxide addition product, 50% in water/isopropanol, Pfersse Chemie), EMA®-81 and EMA®-91 (ethylene-maleic anhydride copolymer, Monsanto), Thickener-QR-1001 (polyurethane emulsion, 19 to 21% in water/diglycol ether, Rohm & Haas), Mirox®-AM (anionic acrylic acid-acrylic acid ester copolymer dispersion, 25% in water, Stockhausen), SER-AD-FX-1100 (hydrophobic urethane polymer, Servo Delden), Shellflo®-S (high molecular weight polysaccharide, stabilized with formaldehyde, Shell) and Shellflo®-XA (xanthan biopolymer, stabilized with formaldehyde, Shell).

A further polymeric thickener which may preferably be used is xanthan, a microbial anionic heteropolysaccharide, which is produced from Xanthomonas campestris and certain other species under aerobic conditions and has a molar mass of 2 to 15 million g/mol. Xanthan is formed from a chain with β-1,4-linked glucose (cellulose) with side chains. The structure of the subgroups consists of glucose, mannose, glucuronic acid, acetate and pyruvate, the number of pyruvate units determining the viscosity of the xanthan.

Xanthans and modified xanthans may be used with particular advantage due to their very extensive stability.

In a preferred embodiment, the textile care agents according to the invention contain thickeners, preferably in quantities of up to 10 wt. %, particularly preferably up to 5 wt. %, in particular of 0.1 to 1 wt. %, in each case relative to the total agent.

In addition, the textile care agents according to the invention may additionally contain odor absorbers and/or dye transfer inhibitors. The use of dye transfer inhibitors has proven useful in particular for the textile care agents according to the invention which assume the form of light-duty detergents, post-treatment agents and liquid washing agents. To deodorize unpleasant smelling formulation constituents, such as for example amine-containing components but also for lasting deodorization of the washed textiles, the use of odor absorbers has proven very helpful.

In a preferred embodiment, the textile care agents according to the invention optionally contain 0.1 wt. % to 2 wt. %, preferably 0.2 wt. % to 1 wt. % of dye transfer inhibitor, which in a preferred development of the invention is a polymer consisting of vinylpyrrolidone, vinylimidazole, vinylpyridine N-oxide or a copolymer thereof. Both polyvinylpyrrolidones with molar weights of 15000 to 50000 and polyvinylpyrrolidones with molar weights of over 1000000, in particular of 1500000 to 4000000, N-vinylimidazole/N-vinylpyrrolidone copolymers, polyvinyloxazolidones, copolymers based on vinyl monomer and carboxamides, pyrrolidone group-containing polyesters and polyamides, grafted polyamidoamines and polyethyleneimines, polyamine N-oxide polymers, polyvinyl alcohols and copolymers based on acrylamidoalkenylsulfonic acids may be used. It is, however, also possible to use enzymatic systems encompassing a peroxidase and hydrogen peroxide or a substance which releases hydrogen peroxide in water. The addition of a mediator compound for the peroxidase, for example of an acetosyringone, of a phenol derivative or of a phenothiazine or phenoxazine, is in this case preferred, wherein the above-stated polymeric dye transfer inhibitor active ingredients may also additionally be used. For use in agents according to the invention, polyvinylpyrrolidone preferably has an average molar mass in the range from 10000 to 60000, in particular in the range from 25000 to 50000. Preferred copolymers are those prepared from vinylpyrrolidone and vinylimidazole in the molar ratio 5:1 to 1:1 having an average molar mass in the range from 5000 to 50000, in particular 10000 to 20000.

Preferred deodorizing substances for the purposes of the invention are one or more metal salts of an unbranched or branched, unsaturated or saturated, mono- or polyhydroxylated fatty acid having at least 16 carbon atoms and/or a resin acid, with the exception of the alkali metal salts, and any desired mixtures thereof.

A particularly preferred unbranched or branched, unsaturated or saturated, mono or polyhydroxylated fatty acid having at least 16 carbon atoms is ricinoleic acid. A particularly preferred resin acid is abietic acid.

Preferred metals are transition metals and lanthanoids, in particular transition metals of the groups VIIIa, Ib and IIb of the periodic table of elements and lanthanum, cerium and neodymium, particularly preferably cobalt, nickel, copper and zinc, extremely preferably zinc. Although cobalt and nickel salts as well as copper salts and zinc salts act in a similar way, for toxicological reasons zinc salts are preferable.

One or more metal salts of ricinoleic acid and/or of abietic acid, preferably zinc ricinoleate and/or zinc abietate, in particular zinc ricinoleate are advantageous and should therefore particularly preferably be used as deodorizing substances.

Further suitable deodorizing substances for the purposes of the invention are likewise cyclodextrins, and mixtures of the above-stated metal salts with cyclodextrin, preferably in a ratio by weight of 1:10 to 10:1, particularly preferably of 1:5 to 5:1 and in particular of 1:3 to 3:1. The term “cyclodextrin” here includes all known cyclodextrins, i.e. both unsubstituted cyclodextrins having 6 to 12 glucose units, in particular alpha-, beta- and gamma-cyclodextrins, and mixtures thereof and/or the derivatives thereof and/or mixtures thereof.

The textile care agents according to the invention may additionally contain further surfactants, for example amphoteric surfactants.

Amphoteric surfactants (zwitterionic surfactants) which may be used according to the invention include betaines, amine oxides, alkylamidoalkylamines, alkyl-substituted amino acids, acylated amino acids or biosurfactants, with betaines being particularly preferred for the purposes of the teaching according to the invention.

Suitable betaines are alkylbetaines, alkylamidobetaines, imidazolinium-betaines, sulfobetaines (INCI Sultaines) and phosphobetaines and preferably comply with the formula IX,

R¹—[CO—X—(CH₂)ₙ]ₓ—N⁺(R²)(R³)—(CH₂)ₘ—[CH(OH)—CH₂]_{y}—Y⁻ (IX)

in which R¹ is a saturated or unsaturated C₆₋₂₂ alkyl residue, preferably C₈₋₁₈ alkyl residue, in particular a saturated C₁₀₋₁₆ alkyl residue, for example a saturated C₁₂₋₁₄ alkyl residue, X is NH, NR⁴ with the C₁₋₄ alkyl residue R⁴, O or S, n is a number from 1 to 10, preferably 2 to 5, in particular 3, x is 0 or 1, preferably 1, R², R³ are mutually independently a C₁₋₄ alkyl residue, optionally hydroxy-substituted, such as for example a hydroxyethyl residue, but in particular a methyl residue, m is a number from 1 to 4, in particular 1, 2 or 3, y is 0 or 1 and Y is COO, SO₃, OPO(OR⁵)O or P(O)(OR⁵)O, in which R⁵ is a hydrogen atom or a C₁₋₄ alkyl residue.

Preferred amphoteric surfactants are alkylbetaines of the formula (IXa), alkylamidobetaines of the formula (IXb), sulfobetaines of the formula (IXc) and the amidosulfobetaines of the formula (IXd),

R¹—N⁺(CH₃)₂—CH₂COO⁻ (IXa)

R¹—CO—NH—(CH₂)₃—N⁺(CH₃)₂—CH₂COO⁻ (IXb)

R¹—N⁺(CH₃)₂—CH₂CH(OH)CH₂SO₃⁻ (IXc)

R¹—CO—NH—(CH₂)₃—N⁺(CH₃)₂—CH₂CH(OH)CH₂SO₃⁻ (IXd)

in which R¹ has the same meaning as in formula IX.

Particularly preferred amphoteric surfactants are carbobetaines, in particular carbobetaines of the formula (IXa) and (IXb), extremely preferably alkylamidobetaines of the formula (IXb).

Examples of suitable betaines and sulfobetaines are the following compounds according to INCI nomenclature: Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Carnitine, Palm Kernelamidopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine and Wheat Germamidopropyl Betaine.

Amine oxides which are suitable according to the invention include alkylamine oxides, in particular alkyldimethylamine oxides, alkylamidoamine oxides and alkoxyalkylamine oxides. Preferred amine oxides comply with formula XI or XII,

R⁶R⁷R⁸N⁺—O⁻ (XI)

R⁶—[CO—NH—(CH₂)_{w}]_{z}—N⁺(R⁷)(R⁸)—O⁻ (XII)

in which R⁶ is a saturated or unsaturated C₆₋₂₂ alkyl residue, preferably C₈₋₁₈ alkyl residue, in particular a saturated C₁₀₋₁₆ alkyl residue, for example a saturated C₁₂₋₁₄ alkyl residue, which is attached to the nitrogen atom N in the alkylamidoamine oxides via a carbonylamidoalkylene group —CO—NH—(CH₂)_{z}— and in the alkoxyalkylamine oxides via an oxaalkylene group —O—(CH₂)_{z}—, in which z in each case denotes a number from 1 to 10, preferably 2 to 5, in particular 3, and R⁷ and R⁸ are mutually independently a C₁₋₄ alkyl residue, optionally hydroxy-substituted such as for example a hydroxyethyl residue, in particular a methyl residue.

Examples of suitable amine oxides are the following compounds according to INCI nomenclature: Almondamidopropylamine Oxide, Babassuamidopropylamine Oxide, Behenamine Oxide, Cocamidopropyl Amine Oxide, Cocamidopropylamine Oxide, Cocamine Oxide, Coco-Morpholine Oxide, Decylamine Oxide, Decyltetradecylamine Oxide, Diaminopyrimidine Oxide, Dihydroxyethyl C₈₋₁₀ Alkoxypropylamine Oxide, Dihydroxyethyl C9-11 Alkoxypropylamine Oxide, Dihydroxyethyl C12-15 Alkoxypropylamine Oxide, Dihydroxyethyl Cocamine Oxide, Dihydroxyethyl Lauramine Oxide, Dihydroxyethyl Stearamine Oxide, Dihydroxyethyl Tallowamine Oxide, Hydrogenated Palm Kernel Amine Oxide, Hydrogenated Tallowamine Oxide, Hydroxyethyl Hydroxypropyl C12-15 Alkoxypropylamine Oxide, Isostearamidopropylamine Oxide, Isostearamidopropyl Morpholine Oxide, Lauramidopropylamine Oxide, Lauramine Oxide, Methyl Morpholine Oxide, Milkamidopropyl Amine Oxide, Minkamidopropylamine Oxide, Myristamidopropylamine Oxide, Myristamine Oxide, Myristyl/Cetyl Amine Oxide, Oleamidopropylamine Oxide, Oleamine Oxide, Olivamidopropylamine Oxide, Palmitamidopropylamine Oxide, Palmitamine Oxide, PEG-3 Lauramine Oxide, Potassium Dihydroxyethyl Cocamine Oxide Phosphate, Potassium Trisphosphonomethylamine Oxide, Sesamidopropylamine Oxide, Soyamidopropylamine Oxide, Stearamidopropylamine Oxide, Stearamine Oxide, Tallowamidopropylamine Oxide, Tallowamine Oxide, Undecylenamidopropylamine Oxide and Wheat Germamidopropylamine Oxide.

Alkylamidoalkylamines (INCI Alkylamido Alkylamines) are amphoteric surfactants of the formula (XIII),

R⁹—CO—NR¹⁰—(CH₂)ᵢ—N(R¹¹)—(CH₂CH₂O)ⱼ—(CH₂)ₖ—[CH(OH)]ₗ—CH₂—Z—OM (XIII)

in which R⁹ is a saturated or unsaturated C₆₋₂₂ alkyl residue, preferably C₈₋₁₈ alkyl residue, in particular a saturated C₁₀₋₁₆ alkyl residue, for example a saturated C₁₂₋₁₄ alkyl residue, R¹⁹ is hydrogen or a C₁₋₄ alkyl residue, preferably H, i is a number from 1 to 10, preferably 2 to 5, in particular 2 or 3, R¹¹ is hydrogen or CH₂COOM, j is a number from 1 to 4, preferably 1 or 2, in particular 1, k is a number from 0 to 4, preferably 0 or 1, l is 0 or 1, in which k=1 if l=1, Z is CO, SO₂, OPO(OR¹²) or P(O)(OR¹²), in which R¹² is a C₁₋₄ alkyl residue or M, and M is hydrogen, an alkali metal, an alkaline earth metal or a protonated alkanolamine, for example protonated mono-, di- or triethanolamine.

Preferred representatives comply with the formulae XIIIa to XIIId,

R⁹—CO—NH—(CH₂)₂—N(R¹¹)—CH₂CH₂O—CH₂—COOM (XIIIa)

R⁹—CO—NH—(CH₂)₂—N(R¹¹)—CH₂CH₂O—CH₂CH₂—COOM (XIIIb)

R⁹—CO—NH—(CH₂)₂—N(R¹¹)—CH₂CH₂O—CH₂CH(OH)CH₂—SO₃M (XIIIc)

R⁹CO—NH—(CH₂)₂—N(R¹¹)—CH₂CH₂O—CH₂CH(OH)CH₂—OPO₃HM (XIIId)

in which R⁹, R¹¹ and M have the same meaning as in formula (XIII). Alkylamidoalkylamines which may be mentioned by way of example are the following compounds according to INCI nomenclature: Cocoamphodipropionic Acid, Cocobetainamido Amphopropionate, DEA-Cocoamphodipropionate, Disodium Caproamphodiacetate, Disodium Caproamphodipropionate, Disodium Capryloamphodiacetate, Disodium Capryloamphodipropionate, Disodium Cocoamphocarboxyethylhydroxypropylsulfonate, Disodium Cocoamphodiacetate, Disodium Cocoamphodipropionate, Disodium Isostearoamphodiacetate, Disodium Isostearoamphodipropionate, Disodium Laureth-5 Carboxyamphodiacetate, Disodium Lauroamphodiacetate, Disodium Lauroamphodipropionate, Disodium Oleoamphodipropionate, Disodium PPG-2-Isodeceth-7 Carboxyamphodiacetate, Disodium Stearoamphodiacetate, Disodium Tallowamphodiacetate, Disodium Wheatgermamphodiacetate, Lauroamphodipropionic Acid, Quaternium-85, Sodium Caproamphoacetate, Sodium Caproamphohydroxypropylsulfonate, Sodium Caproamphopropionate, Sodium Capryloamphoacetate, Sodium Capryloamphohydroxypropylsulfonate, Sodium Capryloamphopropionate, Sodium Cocoamphoacetate, Sodium Cocoamphohydroxypropylsulfonate, Sodium Cocoamphopropionate, Sodium Cornamphopropionate, Sodium Isostearoamphoacetate, Sodium Isostearoamphopropionate, Sodium Lauroamphoacetate, Sodium Lauroamphohydroxypropylsulfonate, Sodium Lauroampho PG-Acetate Phosphate, Sodium Lauroamphopropionate, Sodium Myristoamphoacetate, Sodium Oleoamphoacetate, Sodium Oleoamphohydroxypropylsulfonate, Sodium Oleoamphopropionate, Sodium Ricinoleoamphoacetate, Sodium Stearoamphoacetate, Sodium Stearoamphohydroxypropylsulfonate, Sodium Stearoamphopropionate, Sodium Tallamphopropionate, Sodium Tallowamphoacetate, Sodium Undecylenoamphoacetate, Sodium Undecylenoamphopropionate, Sodium Wheat Germamphoacetate and Trisodium Lauroampho PG-Acetate Chloride Phosphate.

Alkyl-substituted amino acids (INCI Alkyl-Substituted Amino Acids) which are preferred according to the invention are monoalkyl-substituted amino acids according to the formula (XIV),

R¹³—NH—CH(R¹⁴)—(CH₂)ᵤ—COOM′ (XIV)

in which R¹³ is a saturated or unsaturated C₆₋₂₂ alkyl residue, preferably C₈₋₁₈ alkyl residue, in particular a saturated C₁₀₋₁₆ alkyl residue, for example a saturated C₁₂₋₁₄ alkyl residue, R¹⁴ is hydrogen or a C₁₋₄ alkyl residue, preferably H, u is a number from 0 to 4, preferably 0 or 1, in particular 1, and M′ is hydrogen, an alkali metal, an alkaline earth metal or a protonated alkanolamine, for example protonated mono-, di- or triethanolamine, alkyl-substituted imino acids according to the formula (XV),

R¹⁵—N—[(CH₂)ᵥ—COOM″]₂ (XV)

in which R¹⁵ is a saturated or unsaturated C₆₋₂₂ alkyl residue, preferably C₈₋₁₈ alkyl residue, in particular a saturated C₁₀₋₁₆ alkyl residue, for example a saturated C₁₂₋₁₄ alkyl residue, v is a number from 1 to 5, preferably 2 or 3, in particular 2, and M″ is hydrogen, an alkali metal, an alkaline earth metal or a protonated alkanolamine, for example protonated mono-, di- or triethanolamine, in which M″ in the two carboxy groups may have the same or two different meanings, for example hydrogen and sodium or sodium twice, and mono- or dialkyl-substituted natural amino acids according to the formula (XVI),

R¹⁶—N(R¹⁷)—CH(R¹⁸)—COOM′″ (XVI)

in which R¹⁶ is a saturated or unsaturated C₆₋₂₂ alkyl residue, preferably C₈₋₁₈ alkyl residue, in particular a saturated C₁₀₋₁₆ alkyl residue, for example a saturated C₁₂₋₁₄ alkyl residue, R¹⁷ is hydrogen or a C₁₋₄ alkyl residue, optionally hydroxy- or amine-substituted, for example a methyl, ethyl, hydroxyethyl or aminopropyl residue, R¹⁸ is the residue of one of the 20 natural α-amino acids H₂NCH(R¹⁸)COOH, and M′″ is hydrogen, an alkali metal, an alkaline earth metal or a protonated alkanolamine, for example protonated mono-, di- or triethanolamine.

Particularly preferred alkyl-substituted amino acids are the aminopropionates according to the formula (XIVa),

R¹³—NH—CH₂CH₂COOM′ (XIVa)

in which R¹³ and M′ have the same meaning as in formula (XIV).

Alkyl-substituted amino acids which may be mentioned by way of example are the following compounds according to INCI nomenclature: Aminopropyl Laurylglutamine, Cocaminobutyric Acid, Cocaminopropionic Acid, DEA-Lauraminopropionate, Disodium Cocaminopropyl Iminodiacetate, Disodium Dicarboxyethyl Cocopropylenediamine, Disodium Lauriminodipropionate, Disodium Steariminodipropionate, Disodium Tallowiminodipropionate, Lauraminopropionic Acid, Lauryl Aminopropylglycine, Lauryl Diethylenediaminoglycine, Myristaminopropionic Acid, Sodium C12-15 Alkoxypropyl Iminodipropionate, Sodium Cocaminopropionate, Sodium Lauraminopropionate, Sodium Lauriminodipropionate, Sodium Lauroyl Methylaminopropionate, TEA-Lauraminopropionate and TEA-Myristaminopropionate.

Acylated amino acids are amino acids, in particular the 20 natural α-amino acids, which bear on the amino nitrogen atom the acyl residue R¹⁹CO of a saturated or unsaturated fatty acid R¹⁹COOH, in which R¹⁹ is a saturated or unsaturated C₆₋₂₂ alkyl residue, preferably C₈₋₁₈ alkyl residue, in particular a saturated C₁₀₋₁₆ alkyl residue, for example a saturated C₁₂₋₁₄ alkyl residue. The acylated amino acids may also be used as an alkali metal salt, alkaline earth metal salt or alkanolammonium, salt, for example mono-, di- or triethanolammonium salt. Acylated amino acids which may be mentioned by way of example are the acyl derivatives described according to INCI nomenclature among Amino Acids, for example Sodium Cocoyl Glutamate, Lauroyl Glutamic Acid, Capryloyl Glycine or Myristoyl Methylalanine.

In a preferred embodiment, the total surfactant content of the textile care agents, according to the invention, excluding the quantity of fatty acid soap, is below 55 wt. %, preferably below 50 wt. %, particularly preferably between 12 and 48 wt. %, in each case relative to the entire agent.

The textile care agents according to the invention may additionally contain further washing agent additives, for example from the group of builders, bleaching agents, bleaching activators, electrolytes, pH adjusting agents, fragrances, perfume carriers, fluorescent agents, dyes, foam inhibitors, graying inhibitors, antimicrobial active substances, germicides, fungicides, antioxidants, antistatic agents, ironing aids, UV absorbers, optical brighteners, antiredeposition agents, viscosity regulators, shrinkage prevention agents, corrosion inhibitors, preservatives, waterproofing and impregnating agents.

The agents according to the invention may contain builders. Any builders conventionally used in washing and cleaning agents may be introduced into the agents according to the invention, in particular zeolites, silicates, carbonates, organic cobuilders and, provided there is no environmental prejudice against their use, even phosphates.

Suitable crystalline, layered sodium silicates have the general formula NaMSiₓO₂ₓ₊₁.yH₂O, in which M means sodium or hydrogen, x is a number from 1.9 to 4 and y is a number from 0 to 20 and preferred values for x are 2, 3 or 4. Such crystalline phyllosilicates are described, for example, in European patent application EP-A-0 164 514. Preferred crystalline phyllosilicates of the stated formula are those in which M denotes sodium and x assumes the values 2 or 3. In particular, both β- and δ-sodium disilicates Na₂Si₂O₅.yH₂O are preferred.

Amorphous sodium silicates may also be used which have an Na₂O:SiO₂ modulus of 1:2 to 1:3.3, preferably of 1:2 to 1:2.8 and in particular of 1:2 to 1:2.6, which are dissolution-retarded and exhibit secondary washing characteristics. Dissolution retardation relative to conventional amorphous sodium silicates may here have been achieved in various ways, for example by surface treatment, compounding, compaction/compression or by overdrying. For the purposes of the present invention, the term “amorphous” should also be taken to mean “X-ray amorphous”. This means that, in X-ray diffraction experiments, the silicates do not provide any sharp X-ray reflections, as are typical of crystalline substances, but at most one or more maxima of the scattered X-radiation, which have a width of two or more graduations of the diffraction angle. However, particularly good builder characteristics may very well be obtained if, in X-ray diffraction experiments, the silicate particles yield blurred or even sharp diffraction maxima. This should be interpreted to mean that the products comprise microcrystalline domains of a size of 10 to several hundred nm, values of up to at most 50 nm and in particular up to at most 20 nm being preferred. Such “X-ray amorphous” silicates generally likewise exhibit dissolution retardation relative to conventional water glasses. Compressed/compacted amorphous silicates, compounded amorphous silicates, and overdried, X-ray amorphous silicates are particularly preferred.

The finely crystalline, synthetic zeolite containing bound water is preferably zeolite A and/or P. Zeolite MAP® (commercial product from Crosfield) is particularly preferred as zeolite P. However, zeolite X and mixtures of A, X and/or P are also suitable. A co-crystalline product of zeolite X and zeolite A (approx. 80 wt. % zeolite X), which is distributed by CONDEA Augusta S.p.A. under the trade name VEGOBOND AX® and may be described by the formula

nNa₂O.(1−n)K₂O.Al₂O₃.(2-2.5)SiO₂.(3.5-5.5)H₂O

is commercially obtainable and preferably usable for the purposes of the present invention Suitable zeolites have an average particle size of less than 10 μm (volume distribution; measurement method: Coulter Counter) and preferably contain 18 to 22 wt. %, in particular 20 to 22 wt. %, of bound water. The zeolites may also be used as overdried zeolites with lower water contents and are then, thanks to their hygroscopicity, suitable for removing unwanted residual traces of free water.

Generally known phosphates may, of course, also be used as builder substances, provided that such use should not be avoided on environmental grounds. The sodium salts of orthophosphates, pyrophosphates and in particular of tripolyphosphates are particularly suitable.

Further suitable builders are polymeric polycarboxylates, these being for example the alkali metal salts of polyacrylic acid or polymethacrylic acid, for example those with a relative molar mass of 500 to 70000 g/mol.

The molar masses stated here for polymeric polycarboxylates are weight-average molar masses Mw of the respective acid form, which may in principle be determined by means of gel permeation chromatography (GPC), a UV detector being used. Measurement is here made relative to an external standard, for example relative to a polyacrylic acid standard, which supplies realistic molecular weight values as a result of its structural relatedness to the polymers under investigation. These values often differ markedly from the molecular weight values in which polystyrenesulfonic acids are used as the standard. The molar masses measured relative to polystyrenesulfonic acids are generally distinctly higher. Suitable polymers are in particular polyacrylates, which preferably have a molecular mass of 2000 to 20000 g/mol. Due to their superior solubility, the short-chain polyacrylates from this group may in turn be preferred, these having molar masses of from 2000 to 10000 g/mol, and particularly preferably of from 3000 to 5000 g/mol.

Suitable polymers may also comprise substances which consist in part or entirely of units of vinyl alcohol or the derivatives thereof.

Also suitable are copolymeric polycarboxylates, in particular those of acrylic acid with methacrylic acid and acrylic acid or methacrylic acid with maleic acid. Copolymers of acrylic acid with maleic acid containing 50 to 90 wt. % acrylic acid and 50 to 10 wt. % maleic acid have proven particularly suitable. Their relative molecular mass, relative to free acids, amounts in general to 2000 to 70000 g/mol, preferably 20000 to 50000 g/mol and in particular 30000 to 40000 g/mol. The (co)polymeric polycarboxylates may be used either as an aqueous solution or preferably as a powder.

In order to improve water solubility the polymers may also comprise allylsulfonic acids, such as for example allyloxybenzenesulfonic acid and methallylsulfonic acid, as a monomer.

Further preferred copolymers are those which comprise acrolein and acrylic acid/acrylic acid salt or acrolein and vinyl acetate as monomers.

Polymeric aminodicarboxylic acids, the salts thereof or the precursor substances thereof may likewise be mentioned as further preferred builder substances. Polyaspartic acids or the salts and derivatives thereof, which in addition to cobuilder properties are also known to exhibit a bleach stabilizing action, are particularly preferred. Polyvinylpyrrolidones, polyamine derivatives such as quaternized and/or ethoxylated hexamethylenediamines are furthermore suitable.

Further suitable builder substances are polyacetals which may be obtained by reacting dialdehydes with polyolcarboxylic acids which comprise 5 to 7 C atoms and at least 3 hydroxyl groups. Preferred polyacetals are obtained from dialdehydes such as glyoxal, glutaraldehyde, terephthalaldehyde as well as mixtures thereof and from polyolcarboxylic acids such as gluconic acid and/or glucoheptonic acid.

Suitable organic builder substances are moreover dextrins, for example oligomers or polymers of carbohydrates, which may be obtained by partial hydrolysis of starches. Hydrolysis may be carried out in accordance with conventional, for example acid- or enzyme-catalysed, methods. The hydrolysis products are preferably those with average molar masses in the range from 400 to 500000 g/mol. A polysaccharide with a dextrose equivalent (DE) in the range from 0.5 to 40, in particular from 2 to 30 is here preferred, DE being a conventional measure of the reducing action of a polysaccharide in comparison with dextrose, which has a DE of 100. Usable compounds are not only maltodextrins with a DE of between 3 and 20 and dry glucose syrups with a DE of between 20 and 37 but also “yellow” and “white” dextrins with higher molar masses in the range from 2000 to 30000 g/mol. The oxidized derivatives of such dextrins are the reaction products thereof with oxidizing agents which are capable of oxidizing at least one alcohol function of the saccharide ring to yield a carboxylic acid function. An oxidized oligosaccharide is likewise suitable, with a product oxidized on C₆ of the saccharide ring possibly being particularly advantageous.

Oxydisuccinates and other derivatives of disuccinates, preferably ethylenediamine disuccinate, are also further suitable cobuilders. Ethylenediamine-N,N′-disuccinate (EDDS) is here preferably used in the form of the sodium or magnesium salts thereof. Glycerol disuccinates and glycerol trisuccinates are also additionally preferred in this connection. Suitable quantities for use are around 3 to 15 wt. %, in particular in formulations containing zeolite and/or silicate.

Further usable organic cobuilders are, for example, acetylated hydroxycarboxylic acids or the salts thereof, which may optionally also be present in lactone form and which contain at least 4 carbon atoms and at least one hydroxyl group and at most two acid groups.

The agents according to the invention may optionally contain builders in quantities of 1 to 60 wt. %, preferably of 20 to 50 wt. %.

The agents according to the invention may contain bleaching agents.

Among those compounds acting as bleaching agents which release H₂O₂ in water, sodium percarbonate, sodium perborate tetrahydrate and sodium perborate monohydrate are of particular significance. Further usable bleaching agents are for example peroxypyrophosphates, citrate perhydrates and H₂O₂-releasing peracid salts or peracids, such as persulfates or persulfuric acid. The urea peroxyhydrate percarbamide, which may be described by the formula H₂N—CO—NH₂.H₂O₂, is also usable. In particular when using the agents for cleaning hard surfaces, for example in automatic dishwashing, they may if desired also contain bleaching agents from the group of organic bleaching agents, although the use thereof is in principle also possible in textile washing agents. Typical organic bleaching agents are diacyl peroxides, such as for example dibenzoyl peroxide.

Further typical organic bleaching agents are peroxy acids, with examples which may in particular be mentioned being alkylperoxy acids and arylperoxy acids. Preferred representatives which may be used are peroxybenzoic acid and the ring-substituted derivatives thereof, such as alkylperoxybenzoic acids, but also peroxy-α-naphthoic acid and magnesium monoperphthalate, aliphatic or substituted aliphatic peroxy acids, such as peroxylauric acid, peroxystearic acid, ε-phthalimidoperoxycaproic acid (phthalimidoperoxyhexanoic acid, PAP), o-carboxybenzamidoperoxycaproic acid, N-nonenylamidoperadipic acid and N-nonenylamidopersuccinates, and aliphatic and araliphatic peroxydicarboxylic acids, such as 1,12-diperoxycarboxylic acid, 1,9-diperoxyazelaic acid, diperoxysebacic acid, diperoxybrassylic acid, diperoxyphthalic acids, 2-decyldiperoxybutane-1,4-diacid, N,N-terephthaloyldi(6-aminopercaproic acid). Particularly preferably, the agents according to the invention may contain phthalimidoperoxyhexanoic acid (PAP). The bleaching agents may be coated in order to protect them from premature breakdown.

The agents according to the invention may contain bleaching activators.

Bleaching activators which may be used are compounds which, under perhydrolysis conditions, yield aliphatic peroxycarboxylic acids with preferably 1 to 10 C atoms, in particular 2 to 4 C atoms, and/or optionally substituted perbenzoic acid. Suitable substances are those which bear O- and/or N-acyl groups having the stated number of C atoms and/or optionally substituted benzoyl groups. Preferred compounds are repeatedly acylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, triethylacetyl citrate (TEAC), ethylene glycol diacetate, 2,5-diacetoxy-2,5-dihydrofuran and enol ester and acetylated sorbitol and mannitol or mixtures thereof (SORMAN), acylated sugar derivatives, in particular pentaacetyl glucose (PAG), pentaacetyl fructose, tetraacetyl xylose and octaacetyl lactose and acetylated, optionally N-alkylated glucamine and gluconolactone, and/or N-acylated lactams, for example N-benzoylcaprolactam. Hydrophilically substituted acyl acetals and acyl lactams are likewise preferably used. Combinations of conventional bleaching activators may also be used. A further class of preferred bleaching activators are the cationic acetonitrile derivatives RR′R″N⁺CH₂CN, which under perhydrolysis conditions give rise to corresponding perimidic acids.

The agents according to the invention may contain electrolytes.

A wide range of the most varied salts may be used as electrolytes from the group of inorganic salts. Preferred cations are alkali metals and alkaline earth metals; preferred anions are halides and sulfates. From a manufacturing standpoint, it is preferred to use NaCl or MgCl₂ in the agents according to the invention. The proportion of electrolytes in the agents according to the invention amounts conventionally to 0.5 to 5 wt. %.

The agents according to the invention may contain pH adjusting agents.

It may be appropriate to use pH adjusting agents to bring the pH value of the agents according to the invention into the desired range. In this case, any known acids or alkalies may be used, provided that their use is not prohibited for applicational or environmental reasons or for reasons of consumer protection. Conventionally, the quantity of these adjusting agents does not exceed 2 wt. % of the total formulation.

The agents according to the invention may contain colorants and fragrances.

Colorants and fragrances are added to the agents according to the invention in order to improve the aesthetic impression made by the products and to provide the consumer not only with the intended washing and cleaning performance but also with a product which is visually and sensorially “typical and unmistakable”. Perfume oils or fragrances which may be used are individual odoriferous compounds, for example synthetic products of the ester, ether, aldehyde, ketone, alcohol and hydrocarbon type. Odoriferous compounds of the ester type are for example benzyl acetate, phenoxyethyl isobutyrate, p-tert.-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate and benzyl salicylate. Ethers include, for example, benzyl ethyl ether, the aldehydes for example include linear alkanals with 8-18 C atoms, citral, citronellal, citronellyloxyacetaldehyde, cyclamen aldehyde, hydroxycitronellal, lilial and bourgeonal, ketones include, for example, ionones, α-isomethylionone and methyl cedryl ketone, alcohols include anethole, citronellol, eugenol, geraniol, linalool, phenylethyl alcohol and terpineol, hydrocarbons mainly include terpenes such as limonene and pinene. Preferably, however, mixtures of various odoriferous substances are used which together produce an attractive fragrance note. Such perfume oils may also contain natural odoriferous mixtures, as are obtainable from plant sources, for example pine, citrus, jasmine, patchouli, rose or ylang-ylang oil. Likewise suitable are muscatel sage oil, chamomile oil, clove oil, melissa oil, mint oil, cinnamon leaf oil, lime blossom oil, juniper berry oil, vetiver oil, olibanum oil, galbanum oil and labdanum oil and orange-blossom oil, neroli oil, orange peel oil and sandalwood oil.

The agents according to the invention may contain UV absorbers, which key to the treated textiles and improve the lightfastness of the fibers and/or the lightfastness of other formulation ingredients. UV absorbers should be taken to be organic substances (light protection filters) which are capable of absorbing ultra-violet radiation and reemitting the absorbed energy in the form of longer-wave radiation, for example heat. Compounds which have these desired properties are for example compounds active as a result of radiationless deactivation and derivatives of benzophenone with substituents in positions 2 and/or 4. In addition, substituted benzotriazoles, such as for example the water-soluble benzenesulfonic acid-3-(2H-benzotriazol-2-yl)-4-hydroxy-5-(methylpropyl)-monosodium salt (Cibafast® H), acrylates (cinnamic acid derivatives) phenyl-substituted in position 3, optionally with cyano groups in position 2, salicylates, organic Ni complexes and natural substances such as umbelliferone and endogenous urocanic acid are also suitable. Biphenyl and above all stilbene derivatives such as are obtainable commercially from Ciba for example as Tinosorb® FD or Tinosorb® FR are particularly important. UVB absorbers which may be mentioned are 3-benzylidenecamphor or 3-benzylidenenorcamphor and the derivatives thereof, for example 3-(4-methylbenzylidene)camphor; 4-aminobenzoic acid derivatives, preferably 4-(dimethylamino)benzoic acid 2-ethylhexyl ester, 4-(dimethylamino)benzoic acid 2-octyl ester and 4-(dimethylamino)benzoic acid amyl ester; esters of cinnamic acid, preferably 4-methoxycinnamic acid 2-ethylhexyl ester, 4-methoxycinnamic acid propyl ester, 4-methoxycinnamic acid isoamyl ester, 2-cyano-3,3-phenylcinnamic acid 2-ethylhexyl ester (Octocrylene); esters of salicylic acid, preferably salicylic acid 2-ethylhexyl ester, salicylic acid 4-isopropylbenzyl ester, salicylic acid homomethyl ester; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably 4-methoxybenzalmalonic acid di-2-ethylhexyl ester; triazine derivatives, such as for example 2,4,6-trianilino-(p-carbo-2′-ethyl-1′-hexyloxy)-1,3,5-triazine and octyl triazone or dioctyl butamido triazone (Uvasorb® HEB); propane-1,3-diones, such as for example 1-(4-tert.-butyl phenyl)-3-(4′-methoxyphenyl)propane-1,3-dione; ketotricyclo(5.2.1.0)-decane derivatives. Also suitable are 2-phenylbenzimidazole 5-sulfonic acid and the alkali and alkaline earth metal, ammonium, alkylammonium, alkanolammonium and glucammonium salts thereof; sulfonic acid derivatives of benzophenones, preferably 2-hydroxy-4-methoxybenzophenone-5-sulfonic acid and the salts thereof; sulfonic acid derivatives of 3-benzylidenecamphor, such as for example 4-(2-oxo-3-bornylidenemethyl)benzenesulfonic acid and 2-methyl-5-(2-oxo-3-bornylidene)sulfonic acid and the salts thereof.

Typical UVA filters which may be considered are in particular derivatives of benzoylmethane, such as for example 1-(4′-tert.-butylphenyl)-3-(4′-methoxyphenyl)propane-1,3-dione, 4-tert.-butyl-4′-methoxydibenzoylmethane (Parsol 1789), 1-phenyl-3-(4′-isopropylphenyl)-propane-1,3-dione and enamine compounds. The UVA and UVB filters may, of course, also be used in mixtures. Apart from the stated soluble substances, insoluble photoprotective pigments, namely finely dispersed, preferably nanoized metal oxides or salts, may also be considered for this purpose. Examples of suitable metal oxides are in particular zinc oxide and titanium dioxide and also oxides of iron, zirconium, silicon, manganese, aluminum and cerium and mixtures thereof. Silicates (talcum), barium sulfate or zinc stearate may be used as salts. Oxides and salts are already used in the form of pigments for skin-conditioning and skin-protecting emulsions and decorative cosmetics. The particles should here have an average diameter of less than 100 nm, preferably between 5 and 50 nm and in particular between 15 and 30 nm. They may have a spherical shape, but such particles having a shape which is ellipsoidal or differs in another way from spherical may also be used. The pigments may also be surface-treated, i.e. hydrophilized or hydrophobized. Typical examples are coated titanium dioxides, such as for example titanium dioxide T 805 (Degussa) or Eusolex® T2000 (Merck). Silicones in particular, especially trialkoxyoctylsilanes or simethicones, may be considered as hydrophobic coating agents. Micronized zinc oxide is preferably used. UV absorbers are conventionally used in quantities of from 0.01 wt. % to 5 wt. %, preferably of 0.03 wt. % to 1 wt. %.

To assist the corresponding action of the cellulose ether to be used according to the invention, the agents according to the invention may contain additional anticrease agents, since textile fabrics, in particular made from rayon, wool, cotton and mixtures thereof, may have a tendency to crease because the individual fibers are sensitive to bending, kinking, pressing and squeezing transversely of the fiber direction. These include for example synthetic products based on fatty acids, fatty acid esters, fatty acid amides, fatty acid alkylol esters, fatty acid alkylol amides or fatty alcohols, which have generally been reacted with ethylene oxide, or products based on lecithin or modified phosphoric acid esters.

The agents according to the invention may contain graying inhibitors. These have the task of keeping soiling which has been dissolved off the fibers in suspension in the liquor, so preventing redeposition of the soiling. Water-soluble colloids of a mainly organic nature are suitable for this purpose, for example size, gelatin, ether sulfonic acid salts of starch or cellulose or acidic sulfuric acid ester salts of cellulose or starch. Water-soluble polyamides containing acidic groups are also suitable for this purpose. Soluble starch preparations and starch products other than those mentioned above may furthermore be used, for example degraded starch, aldehyde starches etc. Polyvinylpyrrolidone may also be used. Anionic or non-ionic cellulose ethers, such as carboxymethylcellulose (Na salt), methylcellulose, hydroxyalkylcellulose and mixed ethers, such as methylhydroxyethylcellulose, methylhydroxypropylcellulose and/or methylcarboxymethylcellulose are preferred, however.

In a particularly preferred embodiment the textile care agents according to the invention, preferably liquid washing agents, assume the form of a portion in a wholly or partially water-soluble casing. Portioning makes dispensing easier for the consumer.

The textile care agents may in this case be packaged in film pouches, for example. Pouch packaging made from water-soluble film makes it unnecessary for the consumer to tear open the packaging. In this way, it is easy to dispense an individual portion of the correct proportions for a washing cycle by placing the pouch directly into the washing machine or by putting the pouch into a specific quantity of water, for example in a bucket or bowl or in the wash hand basin or sink. The film pouch enclosing the washing portion dissolves when a specific temperature is reached, without leaving any residue. A portioned washing or cleaning agent preparation is preferably present in a pouch of water-soluble film, in particular in a pouch of (optionally acetalized) polyvinyl alcohol (PVAL), in which at least 70 wt. % of the particles of the washing or cleaning agent preparation have particle sizes of >800 μm.

The prior art already contains numerous methods for producing water-soluble washing agent portions which may be used in principle also for the purposes of the present invention. The best known methods are here the blown film methods with horizontal and vertical sealing seams. The thermoforming method is additionally suitable for producing film pouches or indeed dimensionally stable washing agent portions. The water-soluble casings do not however absolutely have to consist of a film material, but may instead also constitute dimensionally stable containers, which may be obtained for example by means of an injection molding method.

Furthermore, methods are known from the prior art for producing water-soluble capsules from polyvinyl alcohol or gelatin, which in principle offer the possibility of providing capsules filled to a high degree. The methods are based on introducing the water-soluble polymer into a shaping cavity. Filling and sealing of the capsules proceeds either synchronously or in successive steps, in which, in the latter case, the capsules are filled by way of a small opening. The capsules may here be filled using a filling wedge, which is arranged above two drums rotating relative to one another, which comprise hemispherical shells on their surfaces. The drums carry polymer strips, which cover the hemispherical shell cavities. Sealing takes place at the positions at which the polymer strip of the one drum meets the polymer strip of the opposing drum. In parallel therewith, the product is injected into the capsule being formed, the injection pressure of the filling liquid pressing the polymer strips into the hemispherical shell cavities. A further possible production process is based on the so-called Bottle-Pack® method. In this method a tubular preform is introduced into a two-part cavity. The cavity is closed, the lower tube portion being sealed, and then the tube is inflated to form the capsule shape in the cavity, is filled and finally sealed.

The casing material is preferably a water-soluble polymeric thermoplastic, particularly preferably selected from the group comprising (optionally partially acetalized) polyvinyl alcohol, polyvinyl alcohol copolymers, polyvinylpyrrolidone, polyethylene oxide, gelatin, cellulose and the derivatives thereof, starch and the derivatives thereof, blends and composites, inorganic salts and mixtures of the stated materials, preferably hydroxypropylmethylcellulose and/or polyvinyl alcohol blends.

In one embodiment of the invention, the casing material may also consist wholly or partially of the cellulose ether to be introduced into the textile care agents.

The above-described polyvinyl alcohols are commercially available, for example under the trademark Mowiol® (Clariant). Polyvinyl alcohols which are particularly suitable for the purposes of the present invention are for example Mowiol® 3-83, Mowiol® 4-88, Mowiol® 5-88, Mowiol® 8-88 and Clariant L648.

The water-soluble thermoplastic used to produce the portion may additionally optionally comprise polymers selected from the group encompassing acrylic acid-containing polymers, polyacrylamides, oxazoline polymers, polystyrene sulfonates, polyurethanes, polyesters, polyethers and/or mixtures of the above polymers. It is preferred for the water-soluble thermoplastic to comprise a polyvinyl alcohol having a degree of hydrolysis of 70 to 100 mol %, preferably of 80 to 90 mol %, particularly preferably of 81 to 89 mol % and in particular of 82 to 88 mol %. It is also preferred for the water-soluble thermoplastic used to comprise a polyvinyl alcohol having a molecular weight in the range from 10000 to 100000 gmol⁻¹, preferably of 11000 to 90000 gmol⁻¹, particularly preferably of 12000 to 80000 gmol⁻¹ and in particular of 13000 to 70000 gmol⁻¹. It is additionally preferable for the thermoplastics to be present in quantities of at least 50 wt. %, preferably of at least 70 wt. %, particularly preferably of at least 80 wt. % and in particular of at least 90 wt. %, in each case relative to the weight of the water-soluble polymeric thermoplastics. The polymeric thermoplastics may contain plasticizing auxiliaries for improving the processability thereof. This may be advantageous in particular when polyvinyl alcohol or partially hydrolysed polyvinyl acetate has been selected as the polymeric material for the polyvinyl alcohol. Glycerol, triethanolamine, ethylene glycol, propylene glycol, diethylene or dipropylene glycol, diethanolamine and methyldiethylamine have in particular proven useful as plasticizing auxiliaries. It is advantageous for the polymeric thermoplastics to contain plasticizing auxiliaries in quantities of at least >0 wt. %, preferably of at least 10 wt. %, particularly preferably of at least 20 wt. % and in particular of at least 30 wt. %, in each case relative to the weight of the casing material.

The invention further provides uses of a cellulose ether to be used according to the invention in a textile care agent for improving the water absorption and/or for improving the shape retention of textile fabrics.

The present invention also provides the use of a cellulose ether to be used according to the invention in a textile care agent for reducing linting.

The present invention also provides the use of a cellulose ether to be used according to the invention in a textile care agent for reducing pilling of textile fabric.

The present invention also provides the use of a cellulose ether to be used according to the invention in a textile care agent for facilitating the ironing of textile fabrics.

It has additionally surprisingly been established that the cellulose ethers to be used according to the invention not only reduce creasing and ensure a smooth textile surface but also significantly improve the soft handle of the treated textiles.

The present invention accordingly also provides the use of a cellulose ether to be used according to the invention in a textile care agent for reducing creasing and smoothing and improving the soft handle of textile fabrics.

The present invention also provides a conditioning substrate, which is a substrate which is impregnated and/or saturated with the textile care agent according to the invention.

The substrate material consists of porous materials which are capable of reversibly absorbing and releasing an impregnating liquid. Three-dimensional structures, such as for example sponges, may be used for this purpose, but flat, porous cloths are preferred. They may consist of a fibrous or cellular flexible material, which has sufficient thermal stability to be used in a dryer and is capable of retaining sufficient quantities of an impregnating or coating agent to condition substances effectively without the agent running or bleeding significantly during storage. These cloths include cloths of woven and nonwoven synthetic and natural fibers, felt, paper or foam, such as hydrophilic polyurethane foam.

Conventional cloths of nonwoven material are preferably used here. Nonwovens are generally defined as adhesion-bonded fibrous products which have a mat structure or a layered fiber structure or as those which comprise fiber mats, in which the fibers are distributed in a random arrangement. The fibers may be of natural origin, such as wool, silk, jute, hemp, cotton, linen, sisal or ramie; or they may have been produced synthetically, for instance rayon, cellulose esters, polyvinyl derivatives, polyolefins, polyamides, viscose or polyesters. In general any fiber diameter or linear density is suitable for the present invention. Preferred conditioning substrates according to the invention consist of a nonwoven material which contains cellulose. Due to the random arrangement of the fibers in the non-woven material, which provide excellent strength in all directions, the nonwoven materials used here do not tend to tear or disintegrate if used for example in a conventional domestic tumble dryer. Preferred porous, flat conditioning cloths consist of fibrous material or various such materials, in particular of cotton, dressed cotton, polyamide, polyester or mixtures of these. Preferably the conditioning substrates in cloth form have an area of 0.2 to 0.005 m², preferably of 0.15 to 0.01 m², in particular of 0.1 to 0.03 m² and particularly preferably of 0.09 to 0.06 m². The grammage of the material amounts in this respect conventionally to between 20 and 500 g/m², preferably 25 to 200 g/m², in particular 30 to 100 g/m² and particularly preferably 40 to 80 g/m².

The present invention also provides a conditioning method for conditioning damp textiles by means of the conditioning substrate according to the invention.

The conditioning process is performed by using the conditioning substrate according to the invention in a textile drying process, together with damp textiles which originate for example from a preceding washing process. The textile drying process conventionally takes place in an apparatus for drying textiles, preferably in a domestic tumble dryer.

The invention further provides methods for reducing linting, for reducing pilling, for facilitating ironing, for reducing creasing, for smoothing and/or for improving the soft handle of textile fabrics by bringing textile fabrics into contact with a textile care agent according to the invention and/or a conditioning substrate according to the invention in a textile cleaning and/or drying process.

In their conditioning role, the textile care agents according to the invention may be introduced directly with the damp laundry into a domestic dryer and/or a washing machine.

The textile care agents according to the invention may be produced by simply mixing together and stirring the individual components, as is familiar to a person skilled in the art. The cellulose ethers to be used according to the invention may here be admixed as a solution or suspension, preferably in aqueous form, with an in particular liquid agent and/or, as a dried powder, preferably deposited onto a washing agent constituent as carrier, be compounded or granulated, mixed or tableted or pelletized.

While particular embodiments of the present invention have been illustrated and described, it would be obvious to those skilled in the art that various other changes and modifications can be made without departing from the spirit and scope of the invention.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation.

The following Examples further illustrate the preferred embodiments within the scope of the present invention, but are not intended to be limiting thereof. It is understood that the examples and embodiments described herein are for illustrative purposes only and that various modifications or changes in light thereof will be suggested to one skilled in the art without departing from the scope of the present invention. The appended claims therefore are intended to cover all such changes and modifications that are within the scope of this invention.

### EXAMPLES

### Example 1

### Softness

Table 1 shows liquid formulation M1 according to the invention and the comparison formulation V1. All values are stated in weight percent, in each case relative to the entire agent.

TABLE 1

| | M1 | V1 |
|---|---|---|
| C₁₂₋₁₄ sodium alkyl ether sulfate | 5 | 5 |
| C₁₂-C₁₈ fatty alcohol + 7 EO | 11 | 11 |
| C₁₄₋₁₆ alkyl glucoside | 2 | 2 |
| Trisodium citrate | 1 | 1 |
| Glycerol | 5 | 5 |
| Amine-modified cellulose ether | 1 | — |
| Water | to 100 | to 100 |

Disposable terry towels (100% cotton) were washed 1× and 3× with the washing agent under the following conditions

| | |
|---|---|
| Washing machine: | Miele W 918 |
| Primary washing: | One-wash coloreds cycle |
| Washing | 40° C. |
| temperature: | |
| Liquor volume: | 17 l |
| Water hardness: | 16 German hardness degrees |
| Filler load: | 3.5 kg of clean laundry incl. test fabric (pillow case, |
| | jersey fabric, dishtowels, huckaback weave towels) |

and air dried after each washing. After the 1st and 3rd washing cycle, the softness of the test fabric was determined sensorially in comparison with standards by a group of experienced subjects. The result is significantly positive, if at least 21 of 30 subjects consider the test fabric to be softer than the standard fabric.

After the 1st washing cycle, out of 30 subjects, 26 found the disposable terry towel which had been treated with washing agent M1 to be softer in comparison with the disposable terry towel which had been treated with washing agent V1.

After the 3rd washing cycle, out of 30 subjects, 29 found the disposable terry towel which had been treated with washing agent M1 to be softer in comparison with the disposable terry towel which had been treated with washing agent V1.

### Example 2

### Elasticity

The test textiles stated in Table 2 below were in each case washed with 120 g of the agents stated in Example 1 [water hardness: 16 German hardness degrees] (Miele W308; one-wash cycle 40° C. normal program) and then dried (2 days hanging from a line in a conditioning room at 20° C. and 65% atmospheric humidity).

The washing and drying cycles were in each case repeated 9 times (i.e. 10 washing/drying cycles in total).

The textile to be tested was stretched for 1 minute by 80% of the original length in a dynamometer (Hounsfield H5KS), then released for 3 minutes, after which the remaining residual elongation was measured. Table 2 below shows the residual elongation of the unwashed textile (U) and the residual elongation determined after use of agents M1 and V1 respectively.

TABLE 2
Residual elongation [%]

| Textile | U | V1 | M1 |
|---|---|---|---|
| Pullover (100% cotton) | 28 | 55 | 39 |
| Pullover (76% dressed cotton/19% | 8 | 14 | 8 |
| PA/5% elastane) | | | |

It can be seen that using the agent according to the invention results in a significant improvement in elasticity.

What is claimed is:

1. A textile care agent comprising a nitrogenous cellulose ether of the general formula (I),
((R—O—)₃R_{Cell})_{y} (I)
in which R_{Cell} is the residue of an anhydroglucose unit, the degree of polymerization y is a number from 80 to 65000 and each of the residues R corresponds to the general formula (II),
—(CₐH₂ₐ—O)ₘ—(C_{b}H_{2b}—O)ₙ—(C_{c}H_{2c})ₒ—R¹Yₚ (II)
in which a and b are mutually independently 2 or 3, c is a number from 1 to 10, m and n are mutually independently a number from 0 to 10, o is 0 or 1, R¹ denotes hydrogen, a C₁₋₁₈ alkyl, alkylaryl, arylalkyl or aryl residue, the group —NR²R³(R⁴)_{q}, a C₁₋₁₈ alkyl-, alkylaryl-, arylalkyl- or aryl-carboxylic acid group or a corresponding sodium, potassium or ammonium carboxylate group, R², R³ and R⁴ mutually independently denote hydrogen, a C₁₋₁₈ alkyl, alkylaryl, arylalkyl or aryl residue or a C₁₋₁₈ alkyl-, alkylaryl-, arylalkyl- or aryl-carboxylic acid group or a corresponding sodium, potassium or ammonium carboxylate group, q is 0 or 1, Y denotes an anion and p is a number greater than or equal to zero such that the complete molecule of the formula (I) does not exhibit a charge, providing that, in at least one of the residues R, the grouping —R¹ denotes —NR²R³(R⁴)_{q}.

2. The agent of claim 1, comprising 0.001 wt. % to 5 wt. % of an amine-modified cellulose ether of the general formula (I).

3. The agent of claim 2, comprising 0.1 wt. % to 1 wt. % of an amine-modified cellulose ether of the general formula (I).

4. The agent of claim 1, wherein y is in the range from 200 to 35000.

5. The agent of claim 4, wherein y is in the range from 300 to 20000.

6. The agent of claim 1, wherein, in the compounds according to formula (I), for each grouping R_{Cell} there are present on average 0.01 to 1 residues R¹ which correspond to the grouping —NR²R³(R⁴)_{q}.

7. The agent of claim 6, wherein, in the compounds according to formula (I), for each grouping R_{Cell} there are present on average 0.1 to 0.8 residues R¹ which correspond to the grouping —NR²R³(R⁴)_{q}.

8. The agent of claim 1, wherein, in the compounds according to formula (I), in addition to the groups bearing the quaternary nitrogen atom, carboxymethyl, methyl, ethyl, propyl, hydroxyethyl and/or hydroxypropyl groups are present.

9. The agent of claim 1, wherein the compound according to formula (I) has an average molecular weight Mw of above 10,000.

10. The agent of claim 9, wherein the compound according to formula (I) has an average molecular weight Mw of above 30,000.

11. The agent of claim 1, wherein the compound according to formula (I) has an average molecular weight Mw of between 50,000 and 80,0000.

12. The agent of claim 11, wherein the compound according to formula (I) has an average molecular weight Mw of between 20,0000 and 60,0000.

13. The agent of claim 1, in solid form as a powder, granular product, extrudate, pressed or fused molding, or tablet, or in liquid form as a dispersion, suspension, emulsion, solution, microemulsion, gel, or paste.

14. The agent of claim 1, in the form of a portion in a wholly or partially water-soluble casing.

15. A method for improving water absorption of a textile fabric, comprising contacting the fabric with the textile care agent of claim 1 in a textile cleaning and/or drying process.

16. A method for improving shape retention of a textile fabric, comprising contacting the fabric with the textile care agent of claim 1 in a textile cleaning and/or drying process.

17. A method for reducing pilling of a textile fabric, comprising contacting the fabric with the textile care agent of claim 1 in a textile cleaning and/or drying process.

18. A method for facilitating ironing of a textile fabric, comprising contacting the fabric with the textile care agent of claim 1 in a textile cleaning and/or drying process.

19. A method for reducing creasing or for smoothing and improving the soft hand of a textile fabric, comprising contacting the fabric with the textile care agent of claim 1 in a textile cleaning and/or drying process.

20. A method for reducing linting of a textile fabric, comprising contacting the textile fabric with the textile care agent of claim 1 in a textile cleaning and/or drying process.
